(19) United States
(12) Patent Application Publication
(10) Pub. No.: US 2005/0024903 A1
(43) Pub. Date: Feb. 3, 2005

(54) Half bridge power supply with standby-mode power saving apparatus

(76) Inventor: Ta-Yung Yang, Milpitas, CA (US)

Correspondence Address: J C PATENTS, INC., 4 VENTURE, SUITE 250, IRVINE, CA, 92618, US

(21) Appl. No.: 10/629,159

(22) Filed: Jul. 28, 2003

(51) Int. Cl. H02M 3/24

(52) U.S. Cl. 363/98

(57) ABSTRACT

The present invention provides a power saving apparatus for a half bridge power supply. The main purpose of the present invention is to reduce power consumption during standby-mode. The present invention includes a switch-apparatus, which is designed such that a start-up resistor will only consume power during normal-mode operation. Another purpose of the present invention is to apply a balance-apparatus for automatically balancing a differential voltage between a high-side capacitor and a low-side capacitor.

### BACKGROUND OF THE INVENTION

1. Field of the Invention

The present invention relates to a power supply and more particularly relates to a half bridge switching power supply.

2. Description of the Related Art

Due to increasingly stringent environment regulations, computer and home appliance manufacturers are under increased pressure to improve power management and reduce energy consumption. US and European regulations regarding power consumption strictly limit the amount of power consumption permitted for supervising and remote-control purposes. Reducing power consumption under standby mode is a major concern.

FIG. 1 shows the input stage of a traditional half bridge switching power supply. This prior-art half bridge switching power supply includes a transistor 30, a transistor 40, a power transistor 10, a power transistor 20, a diode 53, a start-up resistor 55, and a driver transformer 50. The driver transformer 50 includes a current-winding N₁, a drive-winding N_{B1}, a drive-winding N_{B2}, a control-winding N_{D1} and a control-winding N_{D2}. A standby power terminal V_{CC} provides the initial power for the driver transformer 50. The driver transformer 50 is used to switch on the power transistors 10 and 20 via the diode 53 and the start-up resistor 55. When the power transistor 10 is switched on, the current-winding N₁ of the driver transformer 50 will provide a proportional current I_{B1} to drive the power transistor 10. When the power transistor 20 is switched on the current-winding N₁ of the driver transformer 50 will provide a proportional current I_{B2} to drive the power transistor 20. The currents I_{B1} and I_{B2} are given by the following equations:

$${I}_{B1} = \frac{{T}_{NI}}{{T}_{NB1}} \times {I}_{P}$$

$${I}_{B2} = \frac{{T}_{NI}}{{T}_{NB2}} \times {I}_{P}$$

where I_{P} is the current flow through the current-winding N₁, T_{N1} is the turn number of the current-winding N₁; and T_{NB1} and T_{NB2} are the turn numbers of the drive-windings N_{B1} and N_{B2} respectively.

This circuit uses a technique known as proportional switching. By simultaneously turning on the transistors 30 and 40, the control-windings N_{D1}, and N_{D2} will be short-circuited. This will terminate the proportional currents I_{B1} and I_{B2}, and turn off the power transistors 10 and 20. One drawback of this technique is high power consumption during standby mode, while the switching circuit is off.

In order to switch the transistors 30 and 40, the resistance of the start-up resistor 55 must be low. However, if the resistance of the start-up resistor 55 is low, then power consumption will be high while the switching circuit is off.

Furthermore, a bleeding resistor 85 and a bleeding resistor 95 cause significant power dissipation. A negative terminal of a high-side capacitor 80 is connected to a positive terminal of a low-side capacitor 90. The negative terminal of the low-side capacitor 90 is connected to the ground reference. The voltages across the capacitors 80 and 90 are respectively given by,

$${V}_{C80} = \frac{{C}_{90}}{{C}_{80} + {C}_{90}} \times {V}_{IN}$$

$${V}_{C90} = \frac{{C}_{80}}{{C}_{80} + {C}_{90}} \times {V}_{IN}$$

where C₈₀ and C₉₀ are the capacitances of capacitors 80 and 90 respectively, and V_{IN} is the input voltage of the power supply.

If the capacitance of the capacitor 80 and the capacitance of the capacitor 90 differ, then the voltages across each of them will differ as well. Each capacitor has a maximum voltage rating (e.g. 200V). The capacitor 80 or 90 may be easily damaged, if the capacitances vary significantly.

Therefore, the bleeding resistors 85 and 95 are required to reduce the difference between the impedance of the capacitor 80 and the impedance of the capacitor 90. The resistances of the bleeding resistors 85 and 95 should be kept relatively low if the capacitance difference between the capacitors 80 and 90 is high.

If the voltages of the capacitors 80 and 90 are allowed to differ significantly enough, then the energy switched by the power transistors 10 and 20 will also differ. This will result in imbalanced energy switching across a power transformer 60, which can easily damage power transistors and cause transformer saturation. In traditional power supplies, the bleeding resistors 85 and 95 are designed to cope with worst-case scenarios, and thus they consume significant amounts of power.

### SUMMARY OF THE INVENTION

Accordingly, one object of the present invention is to provide a power saving apparatus for a half bridge power supply to reduce power consumption under standby-mode. The present invention reduces power consumption by balancing the voltages of a high-side capacitor and a low-side capacitor. This reduces the amount of power consumed by the power supply's bleeding resistors.

According to one aspect of the present invention, the power saving apparatus includes an N-current-sink connected in parallel with the high-side capacitor and a P-current-sink connected in parallel with the low-side capacitor.

According to another aspect of the present invention, a differential voltage is used to regulate the operation of the N-current sink and P-current-sink in order to prevent voltage imbalance across the two capacitors from occurring. The differential voltage is generated by a resistor network in response to the voltage difference across the low-side capacitor and the high-side capacitor.

According to another aspect of the present invention, to further reduce power consumption, the power supply includes a switch connected in series with a start-up resistor via a diode. The switch is turned off by a control signal while the power supply is under standby-mode. Thus, the start-up resistor only consumes power while the switching circuit operates under normal mode.

The main advantage of the power supply according to the present invention is reduced power consumption under standby-mode. Furthermore, the power supply includes a method of automatically balancing the voltages across the high-side capacitor and the low-side capacitor.

It is to be understood that both the foregoing general descriptions and the following detail descriptions are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows an input stage of a traditional half bridge switching power supply.

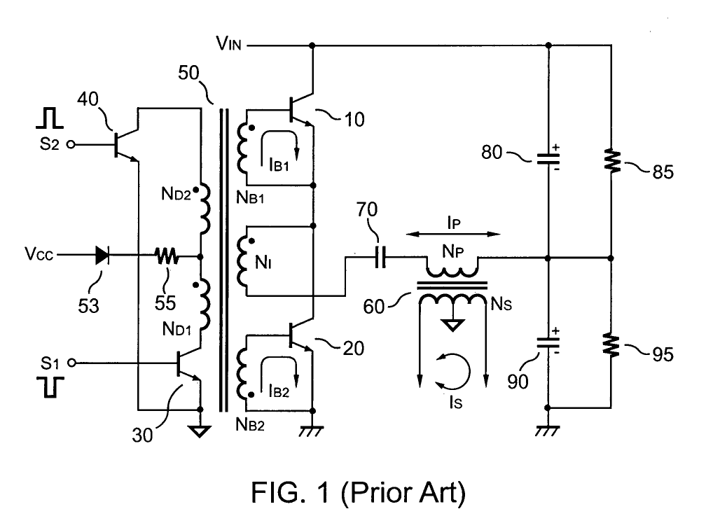

FIG. 2 shows the input stage of a half bridge power supply with a power saving apparatus according to the present invention.

FIG. 3 shows a switch-apparatus that controls the current flow across a start-up resistor of the half-bridge power supply according to a preferred embodiment of the present invention.

### DESCRIPTION OF THE PREFERRED EMBODIMENTS

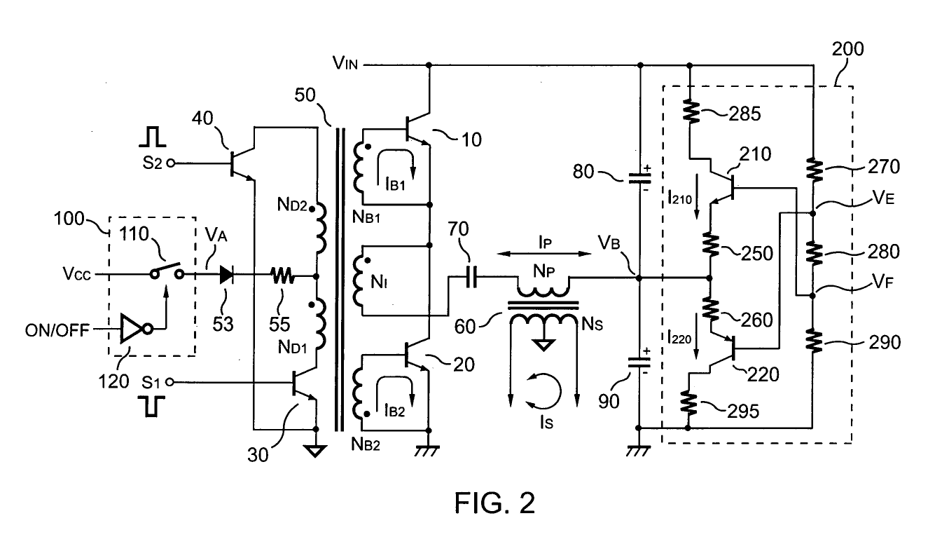

FIG. 2 shows the input stage of a half-bridge power supply with power saving apparatus according to the present invention. The power supply according to the present invention comprises a switch-apparatus 100 and a balance-apparatus 200. The switch-apparatus 100 is connected in series with a start-up resistor 55 via a diode 53. The switch-apparatus 100 is used to control the current flow through the start-up resistor 55. The balance-apparatus 200 is connected in parallel with a high-side capacitor 80 and a low-side capacitor 90. The balance-apparatus 200 is used to sink a current from either the high-side capacitor 80 or the low-side capacitor 90. This is done to balance the differential voltage in between the high-side capacitor 80 and the low-side capacitor 90.

The switch-apparatus 100 comprises a switch 110 and an inverter 120. A first input of the switch-apparatus 100, which is also an input terminal of the switch 110, is connected to a standby power terminal V_{CC}. An output of the switch-apparatus 100, which is also an output terminal of the switch 110, is connected to an anode of the diode 53. A voltage V_{A} is the voltage at the anode of the diode 53. A cathode of the diode 53 is connected in series with the start-up resistor 55. A control signal ON/OFF is supplied to a second input of the switch-apparatus 100, which is also an input of the inverter 120. An output of the inverter 120 controls the switch 110. The control signal ON/OFF is low during normal operation. This closes the switch 110, connecting the start-up resistor 55 with the standby power terminal V_{CC} via the diode 53. During standby-mode, the control signal ON/OFF will turn off the switch 110 and disconnect the start-up resistor 55 from the standby power terminal V_{CC}. In this manner, the start-up resistor 55 is prevented from consuming power during standby-mode.

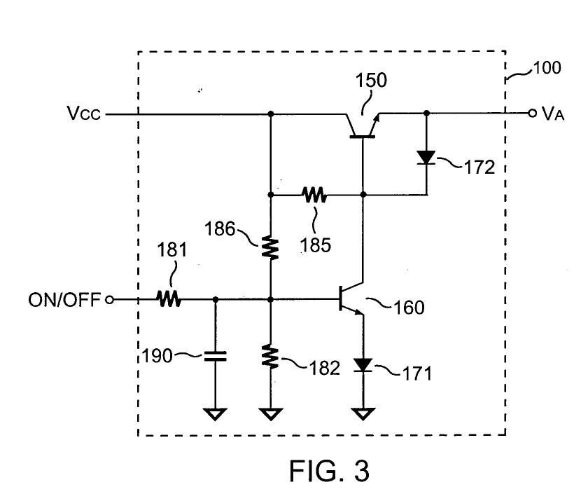

FIG. 3 shows the switch-apparatus 100 according to a preferred embodiment of the present invention. The switch-apparatus 100 comprises a switch-transistor 150, an inverted-transistor 160, a capacitor 190, two diodes 171 and 172, and four resistors 181, 182, 185 and 186. The switch-transistor 150 acts in the same manner as the switch 110. A collector of the switch-transistor 150 is connected to the standby power terminal V_{CC}. An emitter of the switch-transistor 150 supplies the voltage V_{A}. The control signal ON/OFF is supplied to a base of the inverted-transistor 160 via the resistor 181. The capacitor 190 and the resistor 182 are connected in parallel from the base of the inverted-transistor 160 to the ground reference. The diode 171 is connected from an emitter of the inverted-transistor 160 to the ground reference. The inverted-transistor 160 is coupled with the diode 171, the capacitor 190, the resistors 181 and 182, to act in the same manner as the inverter 120. The resistors 185 and 186 provide the bias for the switch-transistor 150 and the inverted-transistor 160 respectively. The diode 172 provides reverse-bias protection for the switch-transistor 150.

Referring to FIG. 2, the balance-apparatus 200 comprises an N-current-sink, a P-current-sink and a resistor network. The resistor network comprises a high-side resistor 270, a threshold resistor 280 and a low-side resistor 290. The N-current-sink includes an n-p-n transistor 210, a N-limit resistor 285 and a N-resistor 250. The P-current-sink includes a p-n-p transistor 220, a P-limit resistor 295, and a P-resistor 260. Via the N-limit resistor 285, a collector of the n-p-n transistor 210 is connected to a positive terminal of the high-side capacitor 80. The input voltage V_{IN} of the power supply is supplied to the positive terminal of the high-side capacitor 80. The positive terminal of the low-side capacitor 90 is connected to a negative terminal of the high-side capacitor 80. The voltage at the positive terminal of the low-side capacitor 90 is the voltage V_{B}. A negative terminal of the low-side capacitor 90 is connected to the ground reference. An emitter of the n-p-n transistor 210 is connected to the negative terminal of the high-side capacitor 80 via the N-resistor 250. The positive terminal of the low-side capacitor 90 is connected to an emitter of the p-n-p transistor 220 via the P-resistor 260. A collector of the p-n-p transistor 220 is connected to the ground reference via the P-limit resistor 295. The high-side resistor 270 and the low-side resistor 290 have the same resistance. The high-side resistor 270 is supplied from the input voltage V_{IN} of the power supply and is connected to the threshold resistor 280. The low-side resistor 290 is connected from the threshold resistor 280 to the ground reference. A base of the n-p-n transistor 210 is connected to the junction of the low-side resistor 290 and the threshold resistor 280. A base of the p-n-p transistor 220 is connected to the junction of the threshold resistor 280 and the high-side resistor 270. This circuit generates a threshold voltage V_{TH} across the threshold resistor 280. The magnitude of the threshold voltage V_{TH} is expressed as:

$${V}_{TH} = \frac{{R}_{280}}{{R}_{270} + {R}_{280} + {R}_{290}} \times {V}_{IN}$$

V_{TH}=V_{E}−V_{F}
where R₂₇₀, R₂₈₀ and R₂₉₀ are respectively the resistances of the resistors 270, 280 and 290; V_{E} is the voltage at the base of the p-n-p transistor 220; and V_{F} is the voltage at the base of the n-p-n transistor 210.

The purpose of threshold voltage V_{TH} is to save power. The n-p-n transistor 210 and the p-n-p transistor 220 will be turned off when the differential voltage of the capacitors 80 and 90 drops below the threshold voltage V_{TH}. Once the differential voltage exceeds the threshold voltage V_{TH}, either the n-p-n transistor 210 or the p-n-p transistor 220 will be activated to perform the adjustment. A current 1210 will be sunk from the high-side capacitor 80. The magnitude of the current 1210 will be proportional to the voltage difference between V_{F} and V_{B}; it can be expressed as,

$${I}_{210} ≅ \frac{( {V}_{F} - {V}_{B} - {V}_{BE} )}{{R}_{250}}$$

where R₂₅₀ is the resistance of the N-resistor 250 and V_{BE} is the base-to-emitter voltage of the n-p-n transistor 210.

A current I₂₂₀ will be sunk from the low-side capacitor 90. The magnitude of the current I₂₂₀ will be proportional to the voltage difference between V_{B} and V_{E}; it can be shown as,

$${I}_{220} ≅ \frac{( {V}_{B} - {V}_{E} - {V}_{BE} )}{{R}_{260}}$$

where R₂₆₀ is the resistance of the P-resistor 260; V_{BE} is the base-to-emitter voltage of the p-n-p transistor 220.

The N-limit resistor 285 and the P-limit resistor 295 are used for protecting the n-p-n transistor 210 and the p-n-p transistor 220 from over-current and/or other abnormal conditions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A power saving apparatus for a half bridge power supply, comprising:
a switch-apparatus, connected in series with a start-up resistor, wherein said switch-apparatus is turned off to disconnect said start-up resistor from a standby power terminal when the power supply operates under standby-mode; and
a balance-apparatus, connected in parallel with a high-side capacitor and a low-side capacitor, wherein said balance-apparatus will sink a current from either said high-side capacitor or said low-side capacitor to balance a differential voltage between said high-side capacitor and said low-side capacitor, wherein a negative terminal of said high-side capacitor is connected with a positive terminal of said low-side capacitor.

2. The power saving apparatus as claimed in claim 1, wherein said switch-apparatus comprises:
a switch connected in series with said start-up resistor; and
an inverter connected to said switch, wherein an input of said inverter is driven by a control signal, wherein an output of said inverter controls said switch, and wherein said switch is turned off by said control signal via said inverter when the power supply operates in standby mode.

3. The power saving apparatus as claimed in claim 1, wherein said balance-apparatus comprises:
a resistor network connected in between a positive terminal of said high-side capacitor and a negative terminal of said low-side capacitor;
an N-current-sink connected in parallel with said high-side capacitor; and
a P-current-sink connected in parallel with said low-side capacitor.

4. The power saving apparatus as claimed in claim 3, wherein said resistor network comprises:
a high-side resistor;
a threshold resistor; and
a low-side resistor connected in series with said high-side resistor via said threshold resistor, wherein the resistance of said high-side resistor is equal to the resistance of said low-side resistor.

5. The power saving apparatus as claimed in claim 3, wherein said N-current sink comprises:
an N-resistor;
an N-limit resistor; and
an n-p-n transistor, wherein a collector of said n-p-n transistor is connected to said positive terminal of said high-side capacitor via said N-limit resistor, wherein an emitter of said n-p-n transistor is connected to said negative terminal of said high-side capacitor via said N-resistor, and wherein a base of said n-p-n transistor is connected to the junction of said low-side resistor and said threshold resistor.

6. The power saving apparatus as claimed in claim 3, wherein said P-current sink comprises:
a P-resistor;
a P-limit resistor; and
a p-n-p transistor, wherein a collector of said p-n-p transistor is connected to said negative terminal of said low-side capacitor via said P-limit resistor, wherein an emitter of said p-n-p transistor is connected to said positive terminal of said low-side capacitor via said P-resistor, and wherein a base of said p-n-p transistor is connected to the junction of said threshold resistor and said high-side resistor.
